(19) United States
(12) Patent Application Publication
(10) Pub. No.: US 2026/0004648 A1
(43) Pub. Date: Jan. 1, 2026

(54) Smart Wireless Movement Detection and Security Alert System

(71) Applicant: Motion Al Labs LLC, Freehold, NJ (US)

(72) Inventor: Ahsan Anwar, Freehold, NJ (US)

(21) Appl. No.: 19/234,192

(22) Filed: Jun. 10, 2025

Related U.S. Application Data
(60) Provisional application No. 63/666,006, filed on Jun. 28, 2024.

(51) Int. Cl. G08B 21/04; G01S 13/50; H04B 17/309

(52) U.S. Cl. CPC G08B 21/043; G01S 13/50; H04B 17/309

(57) ABSTRACT

A system and method of detecting if a person has fallen or is otherwise in distress within a defined region of interest. At least one Wi-Fi transmitter is provided that transmits Wi-Fi signals throughout a region of interest. Wi-Fi signals contain channel state information that is affected by motion patterns of objects within the region of interest. At least one Wi-Fi receiver is used for receiving the Wi-Fi signals that are propagating through the region of interest. The Wi-Fi receivers capture channel state information data streams that contain the changing channel state information of the Wi-Fi signals. The channel state information data streams are analyzed with convolutional neural networks and gated recurrent units to identify the motion patterns within the region of interest. An alarm condition is produced should the motion patterns match known motion patterns that correspond to a person falling or otherwise becoming compromised.

### RELATED APPLICATIONS

This application claims the benefit of U.S. Provisional Application No. 63/666, 006, filed Jun. 28, 2024.

### BACKGROUND OF THE INVENTION

### Field of the Invention

The present invention relates to systems that can passively detect human movement in a building using reflected Wi-Fi signals. More particularly, the present invention relates to Wi-Fi detection systems that can identify when a person in a building has fallen or otherwise requires emergency assistance.

### Prior Art Description

Due to either medical reasons or accident, it is not unusual for a person to fall. Falls can result in injuries and even minor falls can injure the elderly and the frail. Accordingly, detection of movements, especially among the elderly, is paramount for mitigating risks of injuries. Falls can be detected if people are required to wear fall sensors. Likewise, falls can be detected by surveilling a person with cameras. However, these approaches are intrusive, raise privacy concerns, and may not be suitable for continuous monitoring. It is for these reasons that passive monitoring systems, such as Wi-Fi-based monitoring systems, have such appeal. Wi-Fi-based monitoring systems utilize existing wireless Wi-Fi infrastructures to detect and interpret human movements within the coverage area of Wi-Fi signals. This offers a passive, non-intrusive and cost-effective alternative to detecting if a person in a monitored area has fallen.

When a person moves in an area containing Wi-Fi signals, the Channel State Information (CSI) of the Wi-Fi signal changes. CSI provides detailed information about the state of a wireless channel by capturing the amplitude and phase of transmitted signals across multiple subcarriers. When a person moves within a Wi-Fi-covered area, their movements cause fluctuations in the CSI data due to the reflection, scattering, and diffraction of Wi-Fi signals as the Wi-Fi signals propagates from a signal source to a signal receiver. By analyzing these variations, it is possible to identify and classify different types of human activities. Such systems are exemplified by Chinese Publication CN107749143B.

One early implementation of CSI-based Wi-Fi monitoring systems utilized algorithms that are histogram based. Such systems operate by constructing and storing signal distribution histograms under known conditions to develop reference data. During operation, live CSI data histograms are compared to the reference data to classify the detected activity. Such methods are highly sensitive to environmental dynamics. Minor changes in the physical environment, such as the movement of furniture or introduction of new objects, alter the reference data and can significantly affect signal distributions. This results in reduced accuracy and increases false positives.

To improve resilience and classification capability, statistical approaches have also been used in prior art systems. Statistical approaches include logistic regression, support vector machines (SVM), and hidden Markov models (HMM). These techniques identify patterns in CSI data that corresponding to various movements in a monitored space. However, the identified patterns often fall short in dealing with intra-class variability and subtle inter-class differences. This is especially true when operating under changing environmental conditions. Furthermore, reliance on patterns can limit adaptability and generalization.

To overcome these limitations, advanced approaches have emerged that incorporate deep learning architectures, unsupervised representation learning, and sensor fusion methodologies. These innovations aim to provide more robust, accurate, and scalable solutions for human activity detection using passive wireless sensing.

Deep learning architectures utilize neural network models to autonomously identify both the spatial and temporal characteristics that are inherent in CSI data. For example, Convolutional Neural Networks (CNNs) are used to extract spatial features from amplitude and phase components of the reflected Wi-Fi signal. The special features can be used to discriminate between different types of motion. Recurrent Neural Networks (RNNs), particularly long short-term memory (LSTM) architectures, model temporal dependencies in CSI sequences. This enables recognition of activities with dynamic temporal patterns. Hybrid architectures that combine CNN and RNN modules can be used to calculate both spatial and temporal representations. Advanced configurations, such as attention-enhanced bidirectional LSTMs, have been developed to improve classification robustness across varying conditions.

Given the difficulty of acquiring extensive labeled CSI datasets, unsupervised and self-supervised learning strategies have been developed. Self-supervised models can determine generalized representations from unlabeled data, which can later be fine-tuned for specific tasks such as gait analysis or anomaly detection. Geometric and contrastive learning frameworks allow systems to identify discriminative patterns in unlabeled CSI sequences, enhancing robustness to environmental variability and reducing the need for manual annotation.

Lightweight models for edge deployment can be used in real-time applications, especially those deployed on embedded or edge devices with constrained computational resources. Randomized convolutional features have been employed to eliminate training overhead, relying instead on shallow learning classifiers such as ridge regression for final classification. These models maintain reasonable performance while dramatically reducing complexity, making them suitable for deployment on consumer-grade hardware.

To further enhance accuracy and resilience, recent developments incorporate multimodal sensor fusion. In such systems, CSI data is combined with complementary modalities such as visual or inertial sensing. By jointly modeling multiple data streams, such systems leverage the strengths of each modality, enabling more accurate human identification and robust activity recognition under varying environmental and lighting conditions.

Collectively, these technological advancements address the shortcomings of earlier systems and enable the design of passive, accurate, and context-aware movement detection platforms suitable for continuous deployment in sensitive indoor environments. However, despite these advancements, challenges remain in improving detection accuracy, especially in distinguishing between similar activities and adapting to different environmental conditions. A need therefore exists for an improved system where existing Wi-Fi systems and equipment can be utilized to enhance movement detections and/or Wi-Fi signals can be combined with sensors to enhance movement detection capabilities, therein addressing the challenges posed by environmental influences and improving accuracy in distinguishing various human activities. This need is met by the present invention as described and claimed below.

### SUMMARY OF THE INVENTION

The present invention is a system and method of detecting if a person has fallen or is otherwise in distress within a defined region of interest. At least one Wi-Fi transmitter is provided that transmits Wi-Fi signals throughout a region of interest. Wi-Fi signals contain channel state information that is affected by motion patterns of objects within the region of interest.

At least one Wi-Fi receiver is used for receiving the Wi-Fi signals that are propagating through the region of interest. The Wi-Fi receivers capture channel state information data streams that contain the changing channel state information of the Wi-Fi signals. The channel state information data streams are analyzed with convolutional neural networks and gated recurrent units to identify the motion patterns within the region of interest.

An alarm condition is produced should the motion patterns match known motion patterns that correspond to a person falling or otherwise becoming compromised within the region of interest.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 shows a conceptual overview of an exemplary Wi-Fi motion detection system;

FIG. 2 shows a block diagram outlining a methodology of processing Wi-Fi data to detect and identify motion; and

FIG. 3 shows a schematic that outlines the analysis process of converting Wi-Fi data to motion events.

### DETAILED DESCRIPTION OF THE DRAWINGS

Although the present invention system can be embodied in many ways, only one exemplary embodiment is illustrated. The exemplary embodiment is shown for the purposes of explanation and description. The exemplary embodiment is selected in order to set forth one of the best modes contemplated for the invention. The illustrated embodiment, however, is merely exemplary and should not be considered limiting when interpreting the scope of the appended claims.

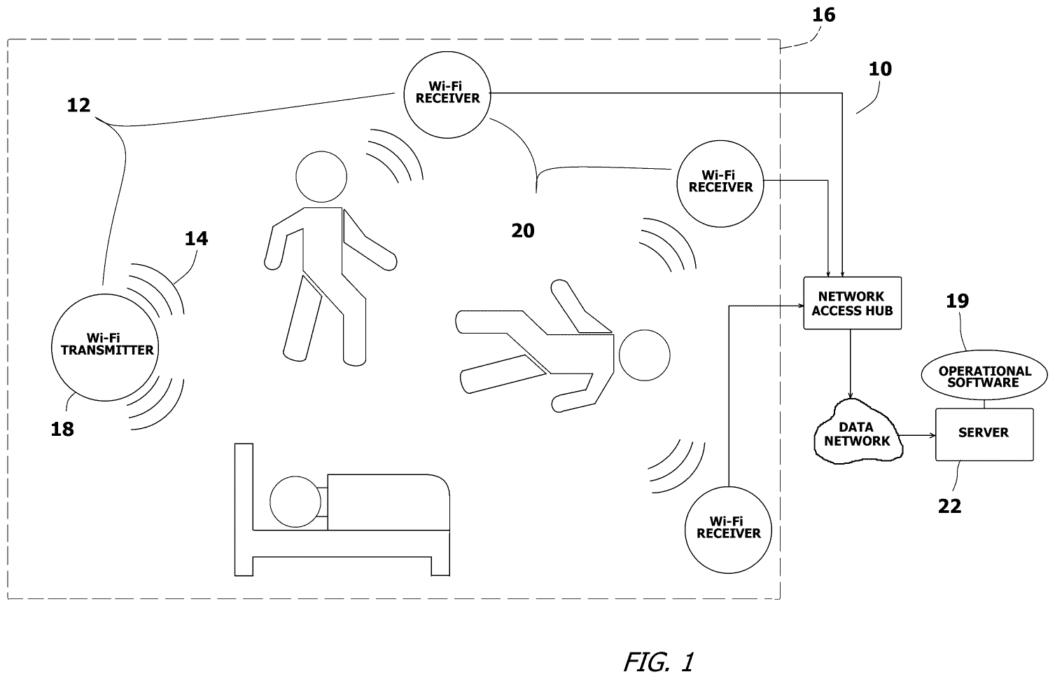

Referring to FIG. 1, a system 10 is shown that contains multiple Wi-Fi devices 12 that can emit and/or receive Wi-Fi signals 14. The Wi-Fi devices 12 can be commercial and/or consumer-grade devices, such as wireless routers, access points, and computing devices with wireless chipsets. These Wi-Fi devices 12 serve the dual purpose of signal emission and signal reception. The Wi-Fi devices 12 continuously emit and/or receive omnidirectional Wi-Fi signals 14 within a designated region of interest 16, such as a suite of rooms. The region of interest 16 is the area of effect of the Wi-Fi signals 14 in a building or other structure.

Although the Wi-Fi devices 12 can include devices that both transmit and receive Wi-Fi signals 14, the Wi-Fi devices 12 will be considered either a Wi-Fi transmitter 18 or a Wi-Fi receiver 20 depending upon its use in the system 10. Dedicated Wi-Fi transmitters 18 and Wi-Fi receivers 20 can also be used. The Wi-Fi transmitters 18 are preferably commercially available products that transmit within standard Wi-Fi frequency bands, which are primarily 2.4 GHZ or 5 GHZ. These transmission frequencies offer favorable propagation and penetration properties for indoor monitoring applications. The use of off-the-shelf Wi-Fi transmitters 18 ensures compatibility and scalability without requiring significant modifications to the environment.

The Wi-Fi receivers 20 perform signal reception by capturing the data of the received Wi-Fi signals 14 to extract and store fine-grained channel measurements. The Wi-Fi receivers 20 are placed at strategic locations within or around the region of interest 16. The Wi-Fi receivers 20 are configured to extract CSI from incoming Wi-Fi signals 14. The CSI identifies the known channel properties of the Wi-Fi communication link. The CSI describes how the Wi-Fi signals 14 propagate from the Wi-Fi transmitters 18 to the Wi-Fi receivers 20 and represent the combined effect of signal scattering, fading, and power decay with distance. The changes to the CSI can be used to detect environmental perturbations in the region of interest 16 caused by human presence and human movement. Since the Wi-Fi receivers 20 constantly receive Wi-Fi signals 14, the Wi-Fi receivers 20 are receiving CSI data streams that are indicative of Wi-Fi signals 14. The CSI data streams comprise amplitude and phase measurements across multiple subcarriers and antenna(s), therein providing detailed spatial and temporal signatures. The Wi-Fi receivers 20 are calibrated to detect subtle variations in the multipath profile of the Wi-Fi signals 14 for the purpose of discerning different types of human motions.

The CSI data streams collected by the Wi-Fi receivers 20 are analyzed by a central processing server 22. The central processing server 22 is either deployed on a local edge device or in a cloud-based infrastructure. The central processing server 22 receives the raw CSI data streams from the Wi-Fi receivers 20. The central processing server 22 is equipped with sufficient computational resources, necessary, to execute real-time signal analysis, feature computation, and neural network inference. The central processing server 22 also stores historical data for audit purposes and manages all alert logic and downstream communications. The central processing server 22 also runs operational software 19 to analyze the incoming Wi-Fi signals.

The designated region of interest 16 can contain various objects that contain electronics, such as cell phones, that emit secondary Wi-Fi signals. Furthermore, stationary underlying objects in the designated region of interest 16 both reflect and block the Wi-Fi signals 14. All such signals are received by the Wi-Fi receivers 20. Within the specified region of interest 16, all objects that reflect or emit signals and potentially causing interference with the reception process at the Wi-Fi receivers 20 are identified. CSI data streams inherently encode variations in the wireless signal path caused by environmental factors, including the presence, motion, and positioning of human subjects. These variations serve as the foundation for subsequent analysis.

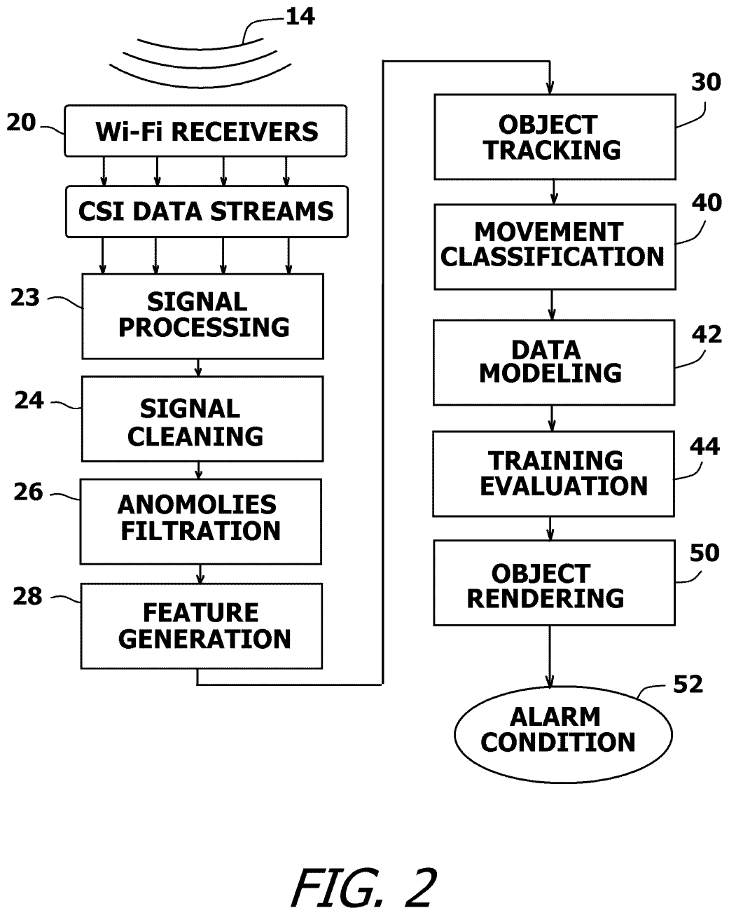

Referring to FIG. 2 in conjunction with FIG. 1, it can be seen that when the various transmitted and reflected Wi-Fi signals 14 are received by the Wi-Fi receivers 20, the Wi-Fi signals 14 must be processed. See Block 23. The first step in processing the raw Wi-Fi signals 14 is signal cleaning. See Block 24. Signal cleaning preprocesses the raw CSI data streams to eliminate noise and enhance signal quality to ensure accurate analysis. The raw CSI data streams have low to high range noise, baseline drift, and distortions due to non-stationary propagation effects. Such noise and distortions are suppressed using signal filtering techniques. Kalman filtering is employed for adaptive noise reduction. Frequency-domain transformations, such as the Fast Fourier Transform (FFT) and wavelet decomposition, are applied to isolate relevant signal components. This step produces a normalized CSI representation that is suitable for downstream processing.

After signal cleaning, the signals undergo anomalies filtration. See Block 26. Anomalies filtration detects and filters out any irregularities or anomalies within the signal data that could potentially distort analysis results. During anomaly filtration, outlier data and spurious fluctuations that are unrelated to human activity are identified and removed. Statistical outlier detection techniques, including Z-score normalization and Isolation Forest algorithms, are applied to ensure that only movement-induced perturbations remain in the filtered dataset. This improves the data for use in pattern recognition models and minimizes false positives.

After anomalies filtration, the data undergoes feature generation. See Block 28. During feature generation, algorithms are used to extract relevant features from the processed CSI data streams. This facilitates subsequent analysis and classification. A comprehensive set of handcrafted features is derived from both the amplitude and phase components of the cleaned CSI signals. These features include basic statistical descriptors such as mean, variance, minimum, and maximum, as well as advanced motion descriptors such as the energy of the signal, first- and second-order differentials, and measures of skewness and kurtosis. Frequency-domain features are computed using FFT-based spectral decomposition, including peak frequencies, power spectral density (PSD), and the mean of real and imaginary frequency components. Autocorrelation features capture the degree of temporal periodicity and are especially useful for modeling cyclic or repetitive human actions. This multi-dimensional feature vector encapsulates both spatial and temporal properties of the observed movements, providing a rich input to the neural inference engine.

Once the cleaned CSI data streams undergo signal processing, then the cleaned CSI data streams are subjected to object detection and tracking. See Block 30. Using real-time computer vision techniques, such as the YOLO (You Only Look Once) and SORT (Simple Online and Realtime Tracking) frameworks, the system 10 detects and treats movement-induced signal variations that are attributable to trackable objects. Trackable objects are objects that change position within a time frame, as opposed to background objects that do not move. Detection techniques that are typically used for visual data are adapted for use with the CSI-based temporal windows. Such techniques include bounding box regression, object classification, and frame-by-frame association. These techniques enable continuous monitoring of individuals within the region of interest 16 and allows the system to reconstruct trajectories and detect movement patterns. The positions and movements of objects are continuously updated. Thus, specific movement patterns, such as those associated with a fall or collapse can be identified as out of the ordinary events.

Along with object tracking, the data is subjected to analysis by movement classification. See Block 40. The first step in movement classification is data modeling. See Block 42. During data modeling, machine models are used to analyze patterns in the data. This can identify different types of movements.

The types of movements are subject to training evaluation. See Block 44. In training evaluation, the performance and accuracy of the trained machine models are utilized to refine and classify results. In post processing, additional analysis and refinement of classified movement data is performed. See Block 46. This enhances the accuracy and reliability of the classification process. Using training in a region of interest 16, the position of objects, such as chairs and couches can be learned. It can also be learned that people often sit in these positions. Thus, the movements associated with sitting on a chair can be distinguished from a person falling in front of a chair or falling in an area where there are no places to sit.

The prepared data can be utilized with object rendering. See Block 50. During object rendering, a visual representation of detected objects and movements is made. The visual rendering is in the format needed for a video monitor so that the visual representation can be viewed. This provides a user-friendly interface for interpreting and analyzing the collected data.

With all data being analyzed, a determination is made as to whether the data corresponds to the conditions of a fall. If a fall is indicated, an alarm condition can be triggered using an alert module. See Block 52. The central processing server 22 monitors the analyzed data for predefined criteria or patterns indicative of targeted events or anomalies. The central processing server 22 triggers alerts or notifications when such occurrences are detected.

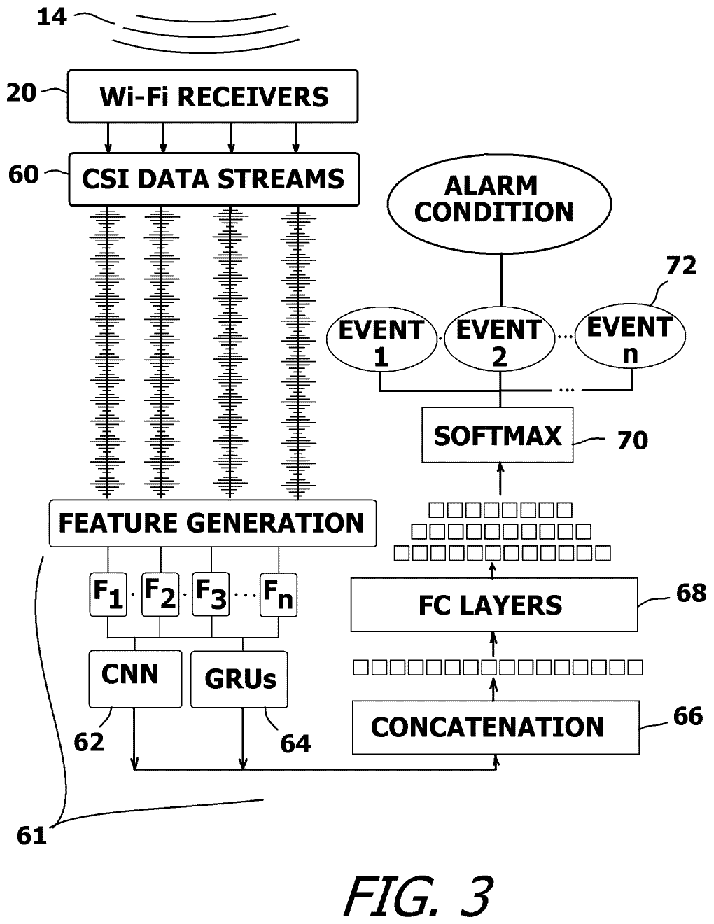

Referring now to FIG. 3 in conjunction with FIG. 1 and FIG. 2, it can be seen that each of the Wi-Fi receivers 20 receive the Wi-Fi signals 14 and produces various CSI data streams 60. After the completion of the signal processing 23 and the object tracking 30, the CSI data streams 60 collected undergo further processing steps using a movement detection system (MDS) 61. Upon the passage of an object through the region of interest 16, abrupt changes in the CSI data steams 60 are detected. These anomalies are pivotal for identifying structural anomalies, as they signify deviations from expected behavior. Leveraging neural network technology, the MDS system captures these singularities in the signal data to discern the presence of damage.

To interpret the complex, nonlinear patterns present in CSI data streams 60, the operational software 19 in the central processing server 22 utilizes a parallel hybrid neural architecture composed of a Convolutional Neural Network (CNN) 62 and a Gated Recurrent Unit (GRU) network 64. This architecture is designed to exploit both the spatial and temporal characteristics of the data in a unified framework.

The CNN 62 is responsible for extracting local spatial features from the multi-dimensional CSI data streams 60. This includes detecting structural signal patterns influenced by motion events such as limb movement, posture changes, or sudden displacements. The CNN 62 is particularly adept at recognizing spatial dependencies across subcarriers and antennas, which are indicative of the spatial orientation and extent of movement within the environment.

While working in parallel, the GRU network 64 processes sequences of CSI data streams 60 to model temporal dependencies. The GRU network 64 maintains a lightweight memory structure that is ideal for tracking time-varying behavior. The GRU network 64 captures the evolution of activity patterns over multiple time steps, enabling accurate recognition of complex, temporally extended events such as walking, falling, or transitioning from sitting to standing.

To improve generalization and prevent model overfitting, dropout regularization layers are strategically embedded within both the CNN 62 and GRU 64 sub-networks. These layers randomly deactivate units during training, forcing the model to learn redundant and distributed representations. This enhances the model's robustness to noise, user variability, and environmental shifts.

The outputs of the CNN 62 and GRU network 64 are concatenated and passed through fully connected (FC) classification layers, which map the learned features to predefined activity classes. See reference number 66 and 68. A softmax function 70 is utilized at the final stage to produce a probability distribution over classes, and the activity with the highest likelihood is selected as the predicted label. The softmax function 70 converts a tuple of real numbers into a probability distribution of possible outcomes and provides a generalization of the logistic function to multiple dimensions. This normalizes the output of the CNN 62 and GRU network 64 to a probability distribution over predicted output classes. The output classes correspond to various events 72. Events, such as walking and sitting can be ignored. Events such as falling or arm flailing can be used to trigger an alert.

Once deployed, the system 10 operates continuously, passively monitoring the defined region of interest 16 without requiring any user intervention or wearable devices. Detected events 72 are timestamped, labeled, and stored. If the system 10 identifies a potentially dangerous situation such as a fall, prolonged inactivity, or erratic movement, the system 10 triggers an emergency response protocol. Alerts may be transmitted via short message service, push notifications, email, or integration with facility management systems. Additionally, all critical events are logged for post-incident review and analysis.

The system 10 offers a fully integrated, intelligent monitoring solution using ambient wireless signals and modern artificial intelligence techniques. By combining handcrafted signal features with neural models trained on real-world CSI data, the system 10 delivers accurate, scalable, and non-invasive human activity detection suitable for healthcare, assisted living, security, and home automation domains.

Accordingly, the system 10 offers a comprehensive solution for precise movement detection utilizing Wi-Fi data that is processed through GRU-based deep learning models. By integrating CNN-GRU parallel architectures and dropout mechanisms, the system 10 enhances accuracy and resilience against overfitting, ensuring robust identification of human activities. This innovative approach improves the efficiency of the Movement Detection Systems in real-time detection, classification, and alerting, ultimately enhancing safety and reducing risks of injuries.

It will be understood that the embodiment of the present invention that is illustrated and described is merely exemplary and that a person skilled in the art can make many variations to that embodiment. All such embodiments are intended to be included within the scope of the present invention as defined by the appended claims.

What is claimed is:

1. A method of detecting if a person has fallen in a region of interest, said method comprising:
providing at least one Wi-Fi transmitter that transmits Wi-Fi signals throughout said region of interest, wherein said Wi-Fi signals contain channel state information that is affected by motion patterns of objects within said region of interest;
providing at least one Wi-Fi receiver for receiving said Wi-Fi signals moving through said region of interest, wherein said Wi-Fi receivers capture channel state information data streams;
analyzing said channel state information data streams with convolutional neural networks and gated recurrent units to identify said motion patterns within said region of interest; and
indicating an alarm condition should said motion patterns match known motion patterns that correspond to a person falling within said region of interest.

2. The method according to claim 1, further including a central processing server that receives said channel state information data streams and analyzes said channel state information data streams with said convolutional neural networks and said gated recurrent units.

3. The method according to claim 1, further including signal cleaning said channel state information data streams to eliminate noise and enhance signal quality.

4. The method according to claim 3, further including applying anomaly filtration to said channel state information data streams after said signal cleaning.

5. The method according to claim 4, wherein said channel state information data streams contain outlier data and spurious fluctuations that are removed by said anomaly filtration.

6. The method according to claim 5, wherein said channel state information data streams contain static data that is unrelated to human activity in said region of interest, wherein said static data is removed by said anomaly filtration.

7. The method according to claim 3, further including applying real-time computer vision techniques to detect signal variations in said channel state information data streams that are attributable to objects that move in said region of interest.

8. The method according to claim 3, further including sorting said objects that move into movement classifications.

9. The method according to claim 8, further including applying a softmax function to produce a probability distribution over said movement classifications.

10. The method according to claim 1, wherein said channel state information data streams contain local spatial features and said convolutional neural networks extract said local spatial features from said channel state information data streams.

11. The method according to claim 1, wherein said convolutional neural networks and said gated recurrent units are concatenated and passed through fully connected classification layers for mapping.

12. A method of classifying movements of a person in a region of interest, said method comprising:
providing at least one Wi-Fi transmitter that transmits Wi-Fi signals throughout said region of interest, wherein said Wi-Fi signals contain channel state information that is affected by movements of a person within said region of interest;
providing at least one Wi-Fi receiver for receiving said Wi-Fi signals, wherein said at least one Wi-Fi receiver captures channel state information data streams;
filtering said channel state information data streams to obtain filtered data;
analyzing said filtered data with convolutional neural networks and gated recurrent units to identify said motion patterns within said region of interest; and
indicating an alarm condition should said motion patterns match known motion patterns that correspond to a person in distress within said region of interest.

13. The method according to claim 12, further including signal cleaning said channel state information data streams to eliminate noise and enhance signal quality.

14. The method according to claim 13, wherein said channel state information data streams contain outlier data and spurious fluctuations and said filtering of said channel state information data streams removes at least some of said outlier data and said spurious fluctuations.

15. The method according to claim 14, wherein said channel state information data streams contain static data that is unrelated to human activity in said region of interest, wherein said static data is removed by said filtering.

16. The method according to claim 12, further including applying real-time computer vision techniques to detect signal variations in said channel state information data streams that are attributable to objects that move in said region of interest.

17. The method according to claim 16, further including sorting said objects that move into movement classifications.

18. The method according to claim 17, further including applying a softmax function to produce a probability distribution over said movement classifications.

19. The method according to claim 12, wherein said channel state information data streams contain local spatial features and said convolutional neural networks extract said local spatial features from said channel state information data streams.
